(19) United States
(12) Patent Application Publication
(10) Pub. No.: US 2004/0044110 A1
(43) Pub. Date: Mar. 4, 2004

(54) Precision process for producing ceramic composite bodies

(75) Inventors: Theo te Baay, Gerolstein (DE); Ralf Sindelar, Norsingen-Ehrenkirchen (DE); Peter Greil, Weisendorf (DE)

Correspondence Address: BURNS, DOANE, SWECKER & MATHIS, L.L.P., P.O. Box 1404, Alexandria, VA, 22313-1404, US

(73) Assignee: Rauschert GmbH, Gerolstein (DE)

(21) Appl. No.: 10/448,015

(22) Filed: May 30, 2003

(30) Foreign Application Priority Data
Jun. 1, 2002 (DE) DE 102 24 377.8

(51) Int. Cl. C08K 3/18; C08K 3/34

(52) U.S. Cl. 524/430; 524/492

(57) ABSTRACT

The invention relates to a process for producing a polyceramic composite-material body, wherein a mixture of one or more polymer materials (i), one or more fillers (ii), and a further reactive component (iii), defined below, are subjected to a first temperature treatment to produce a green body and then to a further temperature treatment, at elevated temperatures that for a mixture without component (iii) lead only to partial pyrolysis; wherein the reactive component (iii) is added, in order to react with the structure-forming components of the polymer materials used and/or the reactive gases present, and by that means extensive dimensional constancy at various durations of pyrolysis and various material thicknesses is attained at an instant at which, without the addition of component (iii), dimensional constancy is not yet attained.

Composite-material bodies that can be produced by the aforementioned process also form one subject of the invention. As an example of reactive components, aluminum and/or magnesium is described in particular.

This application claims priority under 35 U.S.C. §§119 and/or 365 to 102 24 377.8 filed in Germany on Jun. 1, 2002; the entire content of which is hereby incorporated by reference.

### BACKGROUND OF THE INVENTION

The invention relates to a process for producing a polyceramic composite-material body, using a mixture of one or more polymer materials and one or more fillers, characterized in that by adding one or more reactive components, which are capable of reacting with structure-forming components of the polymer materials used and/or with reactive gases that are present, an extensive dimensional constancy at various durations of pyrolysis is attained (plateau phase) at an instant at which, without the addition, dimensional constancy is not yet attained, and in particular as defined in further detail in the main claim a{nd below, as well as to a composite-material body that can be obtained by the process.

### PRIOR ART

From German Patent DE 199 37 322, it is known to obtain polyceramic composite-material bodies with a coefficient of expansion similar to that of a metal and with zero contraction, compared to the original shape, under conditions of partial pyrolysis and both quantitative and qualitative definition of fillers and polymer materials. In the patent cited, only polymer materials and ceramic fillers are named as ingredients for the basic mixture. A disadvantage of the process described in the aforementioned patent is that in large-scale industrial production, particularly of relatively large polyceramic parts, it can be employed only with major restrictions.

The primary reason for this is the absence of process stability. This means in particular a lack of suitability in the production of large batches that are of importance for industrial application. The reason for that is first that when relatively large furnaces, suitable for mass production, are used, the requisite exact, uniform establishment of the requisite temperatures at all points in the particular furnace is feasible only with major engineering effort and thus entails high costs. Second, zero contraction in molded parts of various diameters or with various wall thicknesses can be attained only with difficulty, because the duration of pyrolysis cannot be ignored for the contraction, either. In the case of relatively large molded parts, because of temperature gradients from the outside to the inside, problems arise in establishing suitable conditions for the zero contraction.

For complete pyrolysis, it is known from German Patent DE 39 26 077 to add metal fillers to mixtures of silicon-containing polymers and particles of hard material and/or other reinforcing components. The mixtures obtained are reacted at very high temperatures that lead to complete pyrolysis (in the examples, temperatures of 1000° C. or more are always used), so as to achieve low porosity and to achieve usability along with high mechanical and thermal strength of the ceramic molded bodies that can be obtained. An achievable contraction, zero contraction, or expansion defined in advance and a targeted established coefficient of expansion are not mentioned in the patent cited. At the elevated temperatures, an extremely extensive reaction of the polymer ingredients occurs, so that this text correctly no longer uses the term “polyceramic” but rather only “ceramic” composite bodies. Because of the high temperatures, high energy must be supplied. Particularly for integrating inlay parts of steel or other metals in such composite-material bodies directly in the pyrolysis, it would also be advantageous to be able to use as low temperatures as possible, so that at higher temperatures, phase transitions that occur within the metals (for instance with steels) and the attendant microstructural and dimensional changes, which can for instance lead to stresses and deformations, can be avoided.

The object of the present invention is to make a process available which overcomes the aforementioned disadvantages and which enables simple, replicable production of polyceramic components, even of relatively large dimensions and/or in mass production, particularly with the establishment of a targeted contraction and a targeted coefficient of expansion.

### SUMMARY

The object of the invention is attained surprisingly and in an astonishingly simple way by means of a process as defined by the main claim and a polyceramic composite-material body obtainable by it as defined by the further independent claim and in particular the dependent claims, and as described below.

Surprisingly, it has been found that by means of the presence of reactive components, chemical reactions with the structure-forming ingredients of the polymer component are engendered that enable a rapid polymer-to-ceramic conversion even at low temperatures of below 800 and in fact even below 700° C. As a result, a process course be attained that relatively quickly leads to a stable state, in which over relatively long periods of time, at most only marginal changes in the dimensions of the heated composite-material body occur (development of a plateau phase).

It is thus successfully possible to overcome the disadvantages known from the prior art discussed above: First, it is no longer necessary painstakingly to attain precisely the same temperature conditions at precisely all points of the pyrolysis furnace at precisely the same time or for precisely the same length of time. Second, high temperatures, as are required in DE 39 26 077 for a complete pyrolysis, are no longer necessary. A stable course of the process, even on a large industrial scale, becomes possible.

By means of the reactive additives, it is furthermore attained that the molded bodies obtained have reacted thoroughly, practically homogeneously, after only a short pyrolysis duration, and thus gradients in the composition from the outside to the inside as a result of temperature gradients within the composite-material body are drastically reduced or eliminated, and dimensional homogeneity of the material within the respective composite-material body is assured.

Even in molded parts with different wall thicknesses and diameters (“material thickness”), a uniform dimensional accuracy and thus a targeted establishment of the contraction or expansion or zero contraction can be attained.

The pyrolysis (the second or further temperature treatment) can be carried out in a temperature range in which microstructural changes of inlay parts, for instance comprising steel, do not occur.

It thus becomes possible to attain an economical, stable course of the process. The temperature and duration of pyrolysis can be lowered, meaning less expenditure of energy. The invention is thus based in particular on the use of reactive components to attain dimensional constancy despite variously long reaction times, or in other words to attain high process stability.

In particular, it becomes possible by means of a targeted definition of the material characteristic of contraction or expansion and the coefficient of expansion, by means of precise specification of the qualitative and quantitative substance variables of the reactive and of the passive components and precise specification of the composition of the pyrolysis gas to establish a defined linear dimensional change, compared to the original shape, and preferably at the same time a defined coefficient of expansion. It is thus especially advantageous that the process, in particular because of its easily achieved process stability, is also suitable for producing polyceramic molded bodies with a defined coefficient of expansion and with a defined dimensional change, compared to the original shape, as will be described in further detail below.

### BRIEF DESCRIPTION OF THE DRAWINGS

FIG. 1 shows as an example four curves 1-4 for the time dependency of the dimensional change at various durations for the action of a pyrolysis temperature of 700° C. on polymer/filler/reactive component mixtures (for details, see Example 2). Curve 1 (with the least content of reactive component) is qualitatively equivalent to a curve without the addition of a reactive component.

FIG. 2 schematically shows essential reactions during the pyrolysis, and in particular compares metal carbide formation, which is less preferred to metal oxide formation, which is highly preferred. (5) structure-determining oxygen bridges in the polymer component; (6) functional group (containing carbon); (7) metal oxide formation; (8) metal carbide formation; (9) metal: for instance, Al, Mg, Ca; (10) metal: for instance, B, Ti, Nb, Ta; (11) reaction temperature, (12) extent of reaction.

FIG. 3 shows as an example the time dependency of the dimensional change of a mixture of 30 vol.-% preceramic polymer, 35 vol.-% aluminum oxide, and 35 vol.-% aluminum, in pyrolysis in air at a temperature of 700° C. (13) time (min), (14) expansion (%).

### DETAILED DESCRIPTION OF THE INVENTION

The invention relates primarily to a process for producing a polyceramic composite-material body, wherein a mixture of one or more polymer materials (i), one or more fillers (ii), and a further reactive component (iii), defined below, are subjected to a first temperature treatment to produce a green body and then to a further temperature treatment, at elevated temperatures that for a mixture without component (iii) lead only to partial pyrolysis; the reactive component (iii) is added, in order to react with the structure-forming components of the polymer materials used and/or (preferably, and) the reactive gases present, and by that means to attain extensive dimensional constancy (of the end product) at various durations of pyrolysis and various material thicknesses at an instant at which, without the addition of component (iii), dimensional constancy is not yet attained; the type and ratio of the components (i), (ii) and (iii) and the type of temperature treatment are selected (preferably, must be selected) in particular such that a linear dimensional change defined in advance in the form of an expansion, zero contraction, or contraction, compared to the original shape, is established whose deviation from the defined linear dimensional change (referred to the total linear dimension) is replicably 0.5% or less.

The general terms used above and below preferably have the definitions given below, unless otherwise noted; instead of individual or multiple more-general terms, more-specific definitions can be used, resulting in preferred embodiments of the invention:

A polyceramic composite-material body is understood to mean a ceramic material or in particular a ceramic molded part; the latter can additionally contain, in the composite, materials comprising one or more further materials, such as metal materials, for instance steel or gray cast iron, for instance in the form of inlay parts. The term polyceramic means that in the production, the assumption is a preceramic mixture containing one or more polymer materials, but does not necessarily require that after the pyrolysis, polymer components are still present.

Polymer materials (component (i)) are understood to mean silicon-containing polymers in particular, such as those that contain, as structure-forming components (that is, as components that those of the formula [(R)(R′)SiX]ₙ or [(R)SiX_{1.5}]ₘ, in which R and R′ can represent unsubstituted or substituted radicals selected from the group comprising alkyl, aryl, heterocyclyl, cycloalkyl and the like, and X can stand for SiR₂ (polysilanes), CH₂ (polycarbosilanes), NH (polysilazanes), or O (polysiloxanes), or more-complex copolymers, or mixtures of the aforementioned polymer materials. Oxygen-containing silicon-containing polymers, such as polysiloxanes or silicon-containing polymers containing them (preferably in a proportion of more than 30 and in particular more than 60%), are preferred. Polysiloxane resins are especially preferred. The polymer materials are preferably employed in the form of pastes, powders or granulates. Referred to the preceramic starting mixture, the polymer proportion is preferably in the range from 10 to 60 vol.-%, and in particular from 20 to 50 vol.-%.

“Structure-forming components” of the polymer materials used are those components (atoms and molecular parts) which in the pyrolysis treatment (further temperature treatment) form the polyceramic or ceramic phase that develops as a result of the thermal decomposition from the polymer material and that in the case of polymer in the form of polysiloxane comprises a grasslike (amorphous) network of Si—O—Si which can still contain residues of organic groups (that is, groups containing hydrogen, such as Si—H, Si—CH₂, and the like).

Fillers (components (ii)) are fillers that are maximally inert under the conditions of pyrolysis. These include in particular oxides of metal, such as Al₂O₃, MgO, ZrO₂ (fully stabilized cubic or partly stabilized cubic-tetragonal), Fe₂TiO₅, MgFe₂O₄, CeO₂, CaTiO₃, SiO2 (in particular in the form of quartz), TiO₂; silicates, such as sodium silicate, magnesium silicate, calcium silicate, barium silicate, iron silicate, sodium aluminum silicate, potassium aluminum silicate, or lithium aluminum silicate; nitrides or carbides of metals, in particular of Si, Ti, Zr, Hf, V, Nb, Ta, Cr, Mo and/or W, such as SiC, Si₃N₄ or Cr₃C₂; and also fluorides, such as calcium fluoride. The fillers are used primarily in powdered form. The particle size is preferably in the range below 50 μm, and above all is between 0.5 and 20 μm. The proportion of inert filler, referred to the preceramic starting mixture, is preferably in the range from 10 to 60 vol.-%, and in particular from 20 to 50 vol.-%.

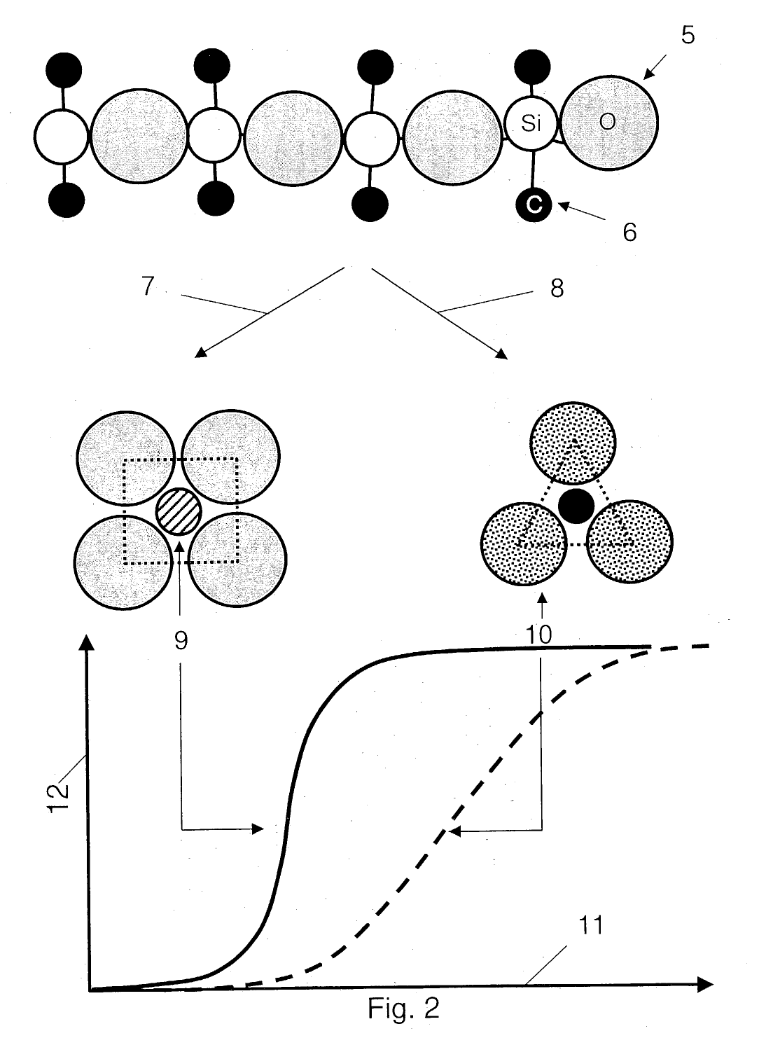

As the reactive components (component (iii)) that (can) react with structure-forming components of the polymer materials used and/or reactive gases present, metals are preferably used, in particular multivalent metals or intermetallic compounds of the fourth through sixth groups of the Periodic System, with boron, silicon and/or aluminum, such as Ti, Zr, Hf, Mo, W, Nb, Ta, V, B, Al, Cr; alkaline earth metals, in particular Mg or Ca; or lanthanides; or CrSi₂, MoSi₂, TiSi₂ or the like, are used. What are preferred are metals with an affinity for oxygen, that is, metals that under the conditions of pyrolysis are reactive with oxygen present in the other components of the particular starting mixture (in particular the polymer portion) and/or, if present, reactive gases that are present, in particular gaseous oxygen (including in gas mixtures such as air, which makes especially preferred simple working conditions possible, since no provisions for insulation against gas exchange are necessary), such metals being in particular Ca, Sr, Zn, Sc, Y, Sn, Zr, or above all Mg and/or Al, that lead to reduced or practically no formation of carbides with existing carbon and simultaneously an increased formation of compounds with existing hetero atoms, in particular oxygen, which makes especially preferred products possible. A process in the presence of oxygen (preferably both in the form of gas and in polymer component (i)) is quite particularly preferred, as are the resultant polyceramic composite-material bodies (since they are largely carbide-free)—see FIG. 2 for illustration. Individual reactive components may be present, or mixtures of two or more of these reactive components. The reactive components are preferably used in the form of powder. The particle size is in particular in the range of below 100 μm, and in particular above all between 5 and 50 μm. The minimum quantity of reactive component required to establish the dimensional constancy can for instance be estimated, by ascertaining the molar quantities of reactive groups and atoms of the polymer component and calculating the stoichiometric quantity of reactive component for the complete reaction. The applicable molar quantity then yields the requisite minimum quantity of the reactive component. Preferably, the quantity of the reactive components, referred to the preceramic starting mixture, is in the range from 2 to 70 vol.-%, preferably 6 to 60 vol.-%, and in particular 10 to 50 vol.-%. The aforementioned reactive components may in part have a kind of autocatalytic effect, because even at relatively low temperature (in part below the melting point of the component (iii) added, for instance in the case of the use of Mg), they enable the reactions that occur in the pyrolysis, while at the same time they themselves take part in the chemical reactions during the pyrolysis. The reaction can already begin below the melting point of the reactive component; the cleavage and structural conversion of the polymer material already occur at substantially lower temperatures than in the filler-controlled high-temperature pyrolysis.

As reactive gases, oxygen or mixtures of oxygen with gases that do not react (are inert) under the conditions of pyrolysis (“further temperature treatment”) are preferred, such as noble gases, nitrogen or carbon dioxide, or air.

Besides the polymer materials, fillers and reactive components, still other additives that can for instance be suited to increasing the consistency or moldability, for instance waxlike substances such as wax, or catalysts such as aluminumacetyl acetonate, or glass frits, may be present, preferably in the range of ≦10 vol.-%, in particular 5 vol.-% or less.

The types of components (i), (ii) and (iii), and optionally other components, are defined by their composition, defined above, and nature (such as particle size and the like).

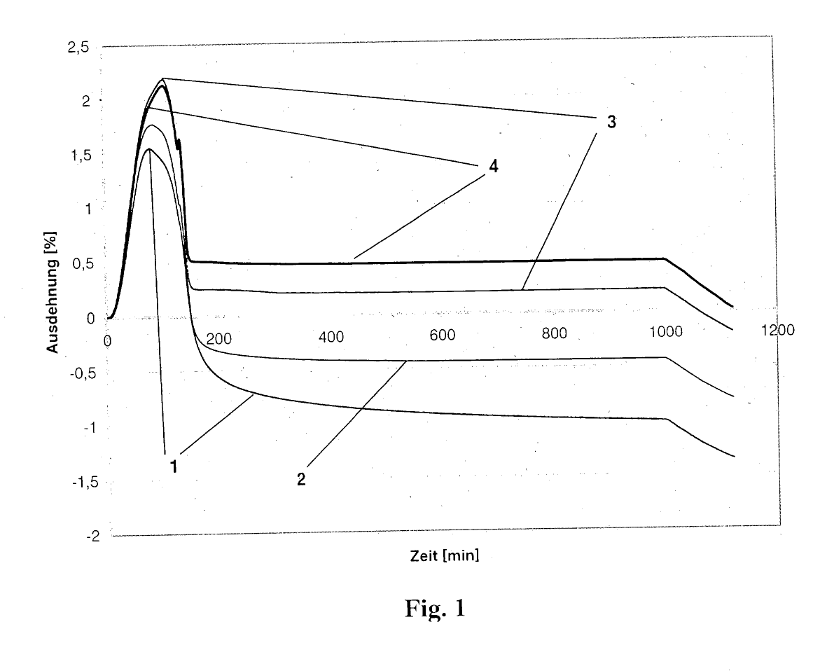

The temperatures for the pyrolysis (second, i.e. further temperature treatment, which under some circumstances may be a temperature leading to only partial pyrolysis; in particular in the presence of oxygen (above all from air) and essentially without carbide) are preferably below 800° C. and preferably between 400 and 790° C., and in particular in the range from 400 to 700° C. For the development of the plateau phase (see for example (2) in FIG. 1), the temperature (minimum temperature of pyrolysis) is determined essentially by the composition; it is preferably in the range of the melting point of the reactive component (iii), or somewhat above it, for instance up to 25° C. higher, or (particularly in the case where Mg is component (iii)) lower, for instance up to 100° C. below this melting point. It is possible for the temperature of pyrolysis to be set higher than the minimum temperature of pyrolysis, or to perform a further temperature treatment at temperatures elevated further compared to the minimum temperature of pyrolysis (preferably always still within the temperature ranges stated above as being preferred), so as to enable a further establishment of the contraction or expansion or zero contraction defined in advance. Preferably (in particular with oxygen-containing polymer materials (i) and/or in the presence of (particularly gaseous) oxygen, as in air), however, a temperature in the range of the plateau will be selected, and no further posttreatment at a further-increased temperature follows.

The type of temperature treatment relates in particular to the variously used rates of change for the temperature upon heating, the maximum temperature, and also the type of cooling.

Dimensional constancy at various durations of pyrolysis, at an instant at which without the addition of the reactive component no dimensional constancy would (yet) be attained, means primarily that the reactions in the pyrolysis proceeds so rapidly that even after only a few hours (in particular after from 2 to 8 hours), dimensional constancy within a tolerance of less than 0.5 and preferably less than 0.1% (referred to a linear dimension), and in particular of less than 0.05% per hour of the duration of pyrolysis is attained, even after a time that is two or more times the time required at the instant of the onset of this dimensional constancy (a plateau occurs; see the horizontal lines in FIG. 1).

What is especially preferred is an embodiment of the invention in which (a) a targeted (previously defined =desired) dimensional change (expansion, contraction, or no change) within a tolerance of 0.5% or less, in particular 0.1% or less, preferably 0.05% or less, is attained; preferably (b) a previously defined linear dimensional change in the range from +5% (expansion) to −5% (contraction), in particular +3% (expansion) to −3% (contraction), compared to the original shape; in both cases, (a) and (b), a defined coefficient of expansion, particularly analogous to that of a metal, above all gray cast iron or steel, that is, primarily in the range from 8 to 15×10⁻⁶K⁻¹ and preferably 9 to 13×10⁻⁶K⁻¹, is preferably additionally established. An especially preferred variant relates here to a zero contraction (that is, essentially or in other words in particular within the limits named below) no change compared to the dimensional change, that is, of less than 0.1 and preferably less than 0.5%, compared to the original shape.

The term “original shape” is understood here to mean the shape predetermined by the original mold.

Ascertaining the [noun missing] for achieving a targeted (linear) dimensional change defined in advance, in particular in combination with a defined coefficient of expansion (TAK), can be done empirically or theoretically or by combining empirical and theoretical methods.

Empirically, for instance, the dimensional change of a composite-material body that is based on one or more polymer materials and one or more inert fillers can be ascertained, and then the quantity of one or more reactive components, in whose presence a defined dimensional change (in particular zero contraction) and preferably simultaneously a defined coefficient of expansion is achieved, can be determined by varying this quantity and keeping the other parameters (in particular the type of pretreatment, the temperature of pyrolysis, the type and nature (such as particle size and optionally coating) of the components used, the type and nature of other additives, the presence or absence and optionally the type of inert gases or other gases, such as oxygen or air, etc.) constant until the desired contraction and in particular the corresponding coefficient of expansion are reached; if necessary, the ratio of polymer material to filler can easily be varied interactively, until the desired parameters are within suitable ranges.

Alternatively, in a kind of three-dimensional matrix analogous to the two-dimensional matrix in German Patent Disclosure DE 199 37 322, polymer material (or polymer materials), fillers and reactive components can be varied directly under otherwise constant conditions, if necessary again with iterative variation of only two parameters, for instance with fine reduction, until the desired defined dimensional change or in particular the defined combination of dimensional change and coefficient of expansion is attained.

Theoretically ascertained data can also be part of the ascertainment of suitable quantitative ratios and pyrolysis temperatures (which, as far as the plateau phase is concerned, are preferably defined by the composition, as described above); see P. Greil, Pyrolysis of Active and Passive Filler Loaded Preceramic Polymers, in Handbook of Advanced Ceramic Materials Science, Ed. S. Somiya, Academic Press, Burlington, Mass. (2002).

Preferably, the processing of the components for the mixing and optionally the reaction to form the green body takes place with the exclusion of water.

Preferably, the polymer material can be applied to the reactive component before mixing with the inert filler material, in order to improve the processing properties (homogeneity of the mixture) and the storage stability of the reactive component.

The shaping and cross-linking of the starting mixture (to form a green body) takes place in the context of the first temperature treatment in a shaping and cross-linking step, for instance in a suitable mold, for instance by mixing and shaping and cross-linking at temperatures of up to 250° C., for instance between 150 and 250° C., or directly in one step in the course of the pyrolysis.

Where not already noted, “dimensional change” means linear dimensional change. That is, the dimensional change is indicated not as a volumetric change but as a linear dimensional change, which means the length of a determined, arbitrarily selected axis of the composite-material body, which is indicated in order to represent the dimensional changes.

Particularly preferred embodiments of the invention are defined by the dependent claims and in particular by the following examples.

### EXAMPLES

### The following examples serve to illustrate the invention, without limiting its scope. All the figures given in percent, as volume percent (vol.-%).

### Example 1

### Consistencies of Various Materials That Can Be Obtained By The Process

Various mixtures of polymer, inert filler and metal powder are investigated. Polymers, catalysts and fillers are for that purpose kneaded in a measurement kneader (polyDrive made by Gebrüder Haake GmbH, Karlsruhe, Germany) at 80° C. for 12 minutes, and the mixture is then coarsely ground (cooled with liquid nitrogen and ground in an oscillating disk mill). The ground powder mixture is then compacted in a steel mold into plates (100×50×3 mm) at 230° C. and 8 MPa. The reaction in each case takes place in air; the pyrolysis setup has the following characteristics: Heating at 5K/min; holding for 4 h at 700° C.; and cooling at 5K/min. The following consistencies are attained:

Polymer Aluminum Oxide Aluminum Magnesium Consistency;

| | | | | Mean Value |
|---|---|---|---|---|
| | | | | [MPa] (Number |
| [vol.-%] | [vol.-%] | [vol.-%] | [vol-%] | of Samples) |
| 30 | 35 | 35 | — | 125 (6) |
| 40 | 15 | 45 | — | 127 (6) |
| 30 | 35 | 30 | 5 | 130 (6) |

Details on the materials:

Al-ac-ac=aluminumacetyl acetonate (catalyst)

Polymer: poly(methylsilsesquioxane), (CH₃SiO_{1.5})ₙ; manufacturer: Wacker Chemie, Burghausen, Germany, type: solid resin MK in powder form; particle size, approximately 20 μm per data sheet, approximately 8 μm measured.

Aluminum Oxide: particle size 0.8 to 1.2 μm, made by Alcoa, type CT 530 SG, mean measured particle size 1.7 μm.

Aluminum: mean particle size 16 μm, Johnson Matthey GmbH, Karlsruhe, Germany, mean measured particle size 17 μm.

Magnesium: mean particle size 50 μm, non ferrum GmbH & Co. KG, St. Georgen, Austria, mean measured particle size: 48 μm.

### Example 2

### Establishing Rapid Dimensional Stability Upon Addition of Aluminum

The addition of aluminum leads to rapid dimensional stability. FIG. 1 shows a dilatometer investigation of a preceramic composition, which is loaded only with an inert filler (comparable to the compositions in DE 199 37 322), and three preceramic compositions to which along with inert fillers (aluminum oxide in both cases), aluminum powder is added as an active component. The reaction in all the tests takes place in nitrogen. While the composition without aluminum still contracts after more than 16 hours of pyrolysis, the composition with aluminum added already reaches its final form after approximately 3 h. After cooling down, the resultant ceramic composite-material body of curve 4 has the same dimensions as the green body before the onset of the pyrolysis (practically zero contraction is achieved). The other curves show that still other contractions can be purposefully established.

| Curve (Reference | Polymer | Aluminum Oxide | Aluminum |
|---|---|---|---|
| Numerals per FIG. 1) | (vol.-%) | (vol.-%) | (vol.-%) |
| 4 | 30 | 35 | 35 |
| 3 | 40 | 30 | 30 |
| 2 | 40 | 50 | 10 |
| 1 | 40 | 55 | 5 |

Curve 1 in FIG. 1 is extensively equivalent to a curve without the addition of reactive component (even after more than 16 hours of pyrolysis, dimensional constancy is not yet attained). One possible explanation is that here the quantity of aluminum is still too slight to enable complete reaction of the reactive groups in the polymer component.

### Example 3

### Reaction in Air

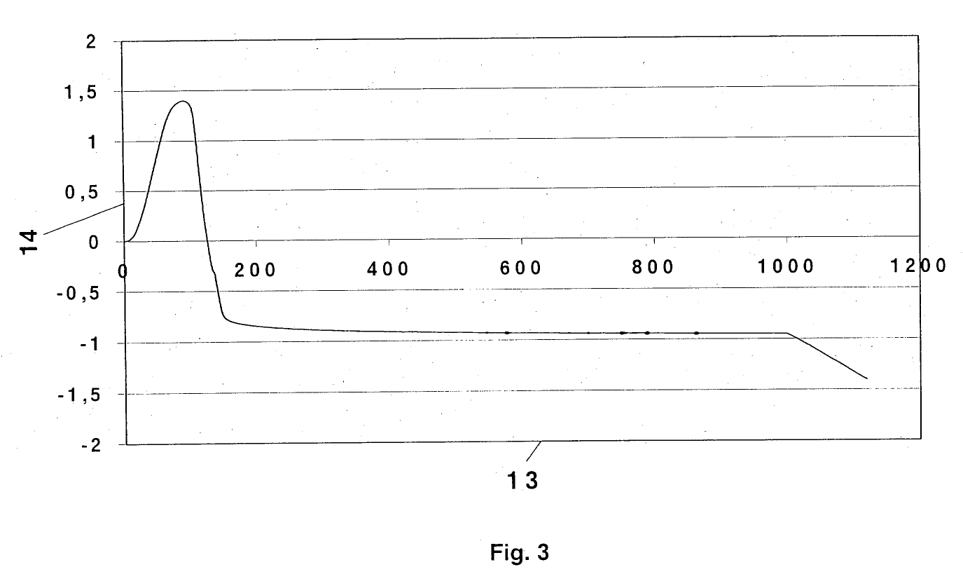

The reaction with the metal powder can advantageously be performed in air. FIG. 3 shows the contraction of a preceramic polymer composition with 35 vol.-% aluminum, 30 vol.-% polymer, and 35 vol.-% aluminum oxide (components each as in Example 1) in reaction in air at 700° C. Even in the pyrolysis in air, the composition achieves dimensional stability after less than ten hours. X-ray refraction examination (Siemens D500 powder diffractometer, CU-Kα, with software Diffrac Plus), it can be shown that in the presence of air, no formation of aluminum carbide occurs. This yields improved properties compared to pyrolysis in an inert gas (nitrogen).

1. A process for producing a polyceramic composite-material body, wherein a mixture of one or more polymer materials (i), one or more fillers (ii), and a further reactive component (iii), defined below, are subjected to a first temperature treatment to produce a green body and then to a further temperature treatment, at elevated temperatures that for a mixture without component (iii) lead only to partial pyrolysis; wherein the reactive component (iii) is added, in order to react with the structure-forming components of the polymer materials used and/or the reactive gases present, and by that means to attain extensive dimensional constancy at various durations of pyrolysis and various material thicknesses at an instant at which, without the addition of component (iii), dimensional constancy is not yet attained; wherein the type and ratio of the components (i), (ii) and (iii) and the type of the second temperature treatment are selected such that a defined linear dimensional change in the form of an expansion, zero contraction, or contraction, compared to the original shape, is established whose deviation from the linear dimensional change defined in advance is replicably 0.5% or less.

2. The process in particular of claim 1 for producing a polyceramic composite-material body, in particular a polyceramic molded part, wherein a mixture of one or more polymer materials (i), one or more fillers (ii), and a further reactive component (iii), defined below, are subjected to a first temperature treatment to produce a green body and then to a further temperature treatment, at elevated temperatures that for a mixture without component (iii) lead only to partial pyrolysis, characterized in that as the reactive component (iii), magnesium, aluminum, or mixtures thereof are used, and after the first temperature treatment, the first temperature treatment is performed at temperatures below 800° C., whereupon a plateau phase is developed in which over relatively long periods of time, only marginal changes, if any, in the dimensions of the heated molded body occur.

3. The process of claim 1, characterized in that the type and ratio of the components (i), (ii) and (iii) and the type of temperature treatment are selected empirically and/or theoretically such that for the ceramic composite-material body, compared to the original shape, a linear dimensional change that is defined in advance, in the range from +5% expansion to −5% contraction, compared to the original shape, is attained.

4. The process of claim 3, characterized in that the type and ratio of the components (i), (ii) and (iii) and the type of the further temperature treatment are selected such that the linear dimensional change defined in advance is in the range from +3% expansion to −3% contraction, compared to the original shape.

5. The process of claim 1, in particular 3 or 4, characterized in that the type and ratio of the components (i), (ii) and (iii) and the type of the further temperature treatment are selected such that a deviation from the linear dimensional change defined in advance that is within a tolerance of 0.5% or less, and in particular 0.1% or less, is attained.

6. The process of claim 1, characterized in that the type and in particular the weight ratios of the components (i), (ii) and (iii) and the type of the further temperature treatment are selected empirically and/or theoretically such that the resultant composite-material body has a coefficient of expansion, defined in advance, and a dimensional change, defined in advance, compared to the original shape, and the dimensional change is replicably within a tolerance of 0.5% or less, preferably 0.1% or less, referred to the dimensional change defined in advance.

7. The process of claim 6, wherein the type and in particular the weight ratios of the components type and the ratio of the components (i), (ii) and (iii) and the type of the further temperature treatment are selected such that the coefficient of expansion, defined in advance, is that of a metal, in particular gray cast iron, and the contraction defined in advance, compared to the original shape, after the second temperature treatment is within a tolerance of 0.5% or less, preferably 0.1% or less, and a linear dimensional change defined in advance is within the range of +5% expansion to −5% contraction, and in particular +3% expansion to −3% contraction, compared to the original shape.

8. The process of claim 1, wherein silicon polymers that contain oxygen are used as the polymer material (i).

9. The process of claim 1, characterized in that the further temperature treatment takes place in the presence of oxygen or air.

10. The process of claim 1, characterized in that the molar quantity of the reactive additive (iii) is selected such that it is equal to or greater than the quantity that is necessary for the complete reaction with the reactive groups or products of decomposition of the polymer materials (i).

11. The process of claim 1, characterized in that the quantity of the reactive component (iii), referred to the preceramic starting mixture, is in the range from 2 to 70 vol.-%, preferably 6 to 60 vol.-%, and in particular 10 to 50 vol.-%.

12. The process of claim 1, characterized in that the temperature of pyrolysis in the further temperature treatment is in a range from 400 to 790° C., in particular 400 to 700° C.

13. A polyceramic composite-material body which can be obtained by a process recited in claim 1.

14. A polyceramic composite-material body, in particular a polyceramic molded part, of claim 13, which in the composite additionally contains materials comprising one or more further materials, in particular metal materials.
